(19) United States
(12) Patent Application Publication
(10) Pub. No.: US 2013/0049264 A1
(43) Pub. Date: Feb. 28, 2013

(54) PROCESS FOR PRODUCING FLEXOGRAPHIC PRINTING PLATE PRECURSOR FOR LASER ENGRAVING, FLEXOGRAPHIC PRINTING PLATE PRECURSOR FOR LASER ENGRAVING AND PROCESS FOR MAKING FLEXOGRAPHIC PRINTING PLATE

(71) Applicants: Katsuhiro YAMASHITA, Shizuoka (JP); Yuusuke KOZAWA, Shizuoka (JP)

(72) Inventors: Katsuhiro YAMASHITA, Shizuoka (JP); Yuusuke KOZAWA, Shizuoka (JP)

(73) Assignee: FUJIFILM CORPORATION, Tokyo (JP)

(21) Appl. No.: 13/599,851

(22) Filed: Aug. 30, 2012

(30) Foreign Application Priority Data
Aug. 31, 2011 (JP) 2011-189865

(51) Int. Cl. B05D 3/02; C08G 61/04; B29C 59/16; B05D 7/24; B32B 37/12

(52) U.S. Cl. 264/400; 427/385.5; 427/521; 156/275.5; 528/396

(57) ABSTRACT

Disclosed are a process for producing a flexographic printing plate precursor for laser engraving, the method comprising, in the following order:
an applying step (1) of applying a composition comprising (Component A) a radical polymerizable compound and (Component B) a thermal radical polymerization initiator onto a support; and a curing step (2) of thermally curing the composition in an atmosphere in which an oxygen partial pressure is from 0.0001 atm to 0.1 atm, a flexographic printing plate precursor for laser engraving produced by the process; a process for making a flexographic printing plate; and a flexographic printing plate.

### CROSS-REFERENCE TO RELATED APPLICATION

This application claims priority under 35 USC 119 from Japanese Patent Application No. 2011-189865, filed on Aug. 31, 2011, the disclosure of which is incorporated by reference herein.

### TECHNICAL FIELD

The present invention relates to a process for producing a flexographic printing plate precursor for laser engraving.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder.

Various processes for producing a printing plate precursor for laser engraving have been suggested.

For example, JP-A-2011-20363 discloses a process for producing a printing plate precursor, comprising a step of disposing a thermosetting composition on the surface of a conductive support and a step of performing high frequency induction heating on the conductive support so as to cure the composition from the surface side contacting the conductive support and to form a resin layer formed of the cured thermosetting composition on the conductive support. JP-A-2011-20363 discloses that when a thick thermosetting composition film is heated, curing proceeds in the inside of the composition without being influenced by oxygen inhibition, but does not proceed on the surface of the composition contacting the atmosphere due to the influence of oxygen inhibition. JP-A denotes a Japanese unexamined patent application publication.

### SUMMARY OF INVENTION

The present inventors have found that when a film which is flexible even at room temperature, such as a relief forming layer of a flexographic printing plate, is thermally cured, polymerization is markedly inhibited due to oxygen in the atmosphere.

An object of the present invention is to provide a process for producing a flexographic printing plate precursor for laser engraving that contains only a small amount of a residual radical polymerizable compound and has a sufficiently cured relief forming layer (recording layer).

The above object of the present invention has been achieved by the following means <1>, <15>, and <16>. Means <2> to <14> as preferable embodiments will also be described.

<1> A process for producing a flexographic printing plate precursor for laser engraving, comprising an applying step (1) of applying a composition comprising (Component A) a radical polymerizable compound and (Component B) a thermal radical polymerization initiator onto a support, and a curing step (2) of thermally curing the composition in an atmosphere in which an oxygen partial pressure is from 0.0001 atm to 0.1 atm.

<2> The process for producing a flexographic printing plate precursor for laser engraving according to <1>, wherein the curing step (2) includes the first thermal curing sub-step of thermally curing at least a portion of a composition layer obtained by application and if necessary, the second thermal curing sub-step of further thermally curing the entire of the composition layer.

<3> The process for producing a flexographic printing plate precursor for laser engraving according to <1> or <2>, wherein a ventilation efficiency of the atmosphere in the curing step (2) is 1% by volume/min to 500% by volume/min.

<4> The process for producing a flexographic printing plate precursor for laser engraving according to any one of <1> to <3>, wherein a heating temperature in the curing step (2) is from 60° C. to 200° C.

<5> The process for producing a flexographic printing plate precursor for laser engraving according to any one of <1> to <4>, wherein the composition further comprises (Component C) a photothermal conversion agent.

<6> The process for producing a flexographic printing plate precursor for laser engraving according to any one of <1> to <5>, wherein the composition further comprises (Component D) a binder polymer.

<7> The process for producing a flexographic printing plate precursor for laser engraving according to any one of <1> to <6>, wherein the composition further comprises (Component E) a cross-linking agent.

<8> The process for producing a flexographic printing plate precursor for laser engraving according to any one of <1> to <7>, wherein the composition comprises (Component A1) a polyfunctional ethylenically unsaturated compound as Component A.

<9> The process for producing a flexographic printing plate precursor for laser engraving according to <7> or <8>, wherein Component E is at least one kind selected from a group consisting of (Component E1) a polyfunctional isocyanate compound, (Component E2) a polyfunctional acid anhydride, and (Component E3) a polyalkoxysilane compound.

<10> The process for producing a flexographic printing plate precursor for laser engraving according to any one of <1> to <9>, further comprising the steps of providing a photocurable composition layer onto the surface of the thermally cured composition, pasting another light-transmissive support onto the photocurable composition layer, and curing the photocurable composition layer with light.

<11> The process for producing a flexographic printing plate precursor for laser engraving according to any one of <1> to <10>, wherein the composition further comprises (Component G) a solvent, and the applying step (1) includes a sub-step of coating the composition onto the support and a following sub-step of removing 95% by weight or more of the solvent from the composition.

<12> The process for producing a flexographic printing plate precursor for laser engraving according to any one of <2> to <11>, comprising, as the curing step (2), the first thermal curing sub-step of thermally curing at least a portion of the composition layer in an atmosphere in which an oxygen partial pressure is from 0.001 atm to 0.05 atm and at 80° C. to 140° C., and the following second thermal curing sub-step of thermally curing the entire of the composition layer in an atmosphere of 1 atm and at 70° C. to 110° C.

<13> The process for producing a flexographic printing plate precursor for laser engraving according to any one of <2> to <12>, wherein a ventilation efficiency in the second thermal curing sub-step is 20% by volume/min to 100% by volume/min.

<14> The process for producing a flexographic printing plate precursor for laser engraving according to any one of <10> to <13>, wherein the photocurable composition layer comprises a (meth)acrylate compound having a hydroxyl group, a (meth)acrylate compound not having a hydroxyl group, and a photopolymerization initiator, and does not comprise volatile organic compounds (VOC) not having an ethylenically unsaturated group.

<15> A flexographic printing plate precursor for laser engraving produced by the process according to any one of <1> to <14>.

<16> A process for making a flexographic printing plate, comprising the steps of engraving the flexographic printing plate precursor according to <15> with laser, and washing the laser-engraved printing plate with water or an aqueous solution.

### DESCRIPTION OF EMBODIMENTS

The process for producing a flexographic printing plate precursor for laser engraving of the present invention is characterized in that the process includes an applying step (1) of applying a composition comprising (Component A) a radical polymerizable compound and (Component B) a thermal radical polymerization initiator onto a support, and a curing step (2) of thermally curing the composition in an atmosphere in which an oxygen partial pressure is from 0.0001 atm to 0.1 atm, as essential steps. Hereinafter, these steps will be described in order.

### <Applying Step (1)>

In the process for producing a flexographic printing plate precursor for laser engraving of the present invention, a first essential step is an applying step (1) of applying a composition comprising (Component A) a radical polymerizable compound and (Component B) a thermal radical polymerization initiator onto a support. Herein, “applying” refers to coating a solvent-containing composition onto a support and then removing (drying) the solvent. In other words, the applying step (1) is a layer forming step of forming a relief forming layer comprising a composition for laser engraving on a support.

In a case of a composition for laser engraving not containing a solvent, the composition can be pushed out of a slit while being heated if necessary, and cast onto a support. This case is also included in the “applying”.

When the composition contains a solvent, the solvent used for preparing the composition is preferably removed in an amount of 95% by weight or more by drying, and more preferably removed in an amount of 99% by weight or more.

A support is now explained that is useful for the process in the present invention.

### <Support>

A material as the support for producing the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

The composition for laser engraving used for producing a flexographic printing plate precursor for laser engraving can be prepared by mixing essential Components which are (Component A) a radical polymerizable compound and (Component B) a thermal radical polymerization initiator as well as one or more kinds among arbitrary components which are Component C (photothermal conversion agent), Component D (binder polymer), and Component E (cross-linking agent) with an appropriate solvent that dissolves or disperses these components so as to dissolve and disperse the components. The order of adding each component can be appropriately selected. The above essential components and arbitrary components will be described later in detail.

The applying step (1) is a layer forming step of forming a relief forming layer comprising the composition for laser engraving on a support.

Preferable examples of methods of forming a relief forming layer include a method of preparing a composition for laser engraving, casting the composition onto a support by a known method, and removing a solvent by drying the resultant in an oven. Examples of the casting method include slit coating, curtain coating, Giesser coating, and the like.

A dry thickness of the relief forming layer is preferably 0.05 mm to 10 mm, more preferably 0.1 mm to 7 mm, and particularly preferably 0.5 mm to 3 mm.

### <Curing Step (2)>

In the process for producing a flexographic printing plate precursor for laser engraving of the present invention, an essential step performed after the applying step (1) is a curing step (2) of thermally curing the composition in an atmosphere where an oxygen partial pressure is from 0.0001 atm to 0.1 atm. The curing step (2) will be described.

The heating temperature in the curing step (2) is preferably from 60° C. to 200° C., more preferably from 60° C. to 150° C., and particularly preferably from 75° C. to 130° C.

The above “oxygen partial pressure” refers to a partial pressure of oxygen in the atmosphere of the thermal curing step, and is defined by the product of a pressure of atmosphere including all of oxygen and other gases and an oxygen concentration (% by volume) in the atmosphere. That is, the following relational expression is established.

Oxygen partial pressure=atmospheric pressure×oxygen concentration (% by volume)

Atmospheric pressure can be measured using a general manometer. An atmospheric pressure as a standard is 1 atm=0.101 MPa.

Oxygen concentration can be determined by sampling the atmosphere in the thermal curing step, returning the atmosphere to an atmosphere of room temperature (25° C.) and normal pressure (1 atm), and then measuring an oxygen concentration in the returned atmosphere by using an oxygen concentration meter. As the principle of measurement of an oxygen concentration meter, a magnetic method, a limiting current method, a zirconia method, a galvanic cell method, and the like are known, and any of the methods may be used for measurement.

The oxygen partial pressure can be adjusted by a method of evacuating the inside of a container in which a thermosetting composition is cured by heating, a method of relatively reducing oxygen concentration by adding inert gas such as nitrogen to the gas supplied into the container, and a combination of these methods.

An internal oxygen partial pressure of the container used for the heating step is 0.0001 atm to 0.1 atm, preferably 0.0001 atm to 0.05 atm, and more preferably 0.001 atm to 0.01 atm.

The residual solvent in the applying step (1) is preferably removed in the curing step (2). The residual solvent can be efficiently reduced particularly in an atmosphere with reduced pressure, or by ventilating this atmosphere.

The curing step (2) preferably includes the first thermal curing sub-step of thermally curing at least a portion of the composition layer obtained by application, and the second thermal curing sub-step of further thermally curing the entire of the composition layer. These two thermal curing sub-steps will be described later in detail. Even with one step curing that comprises only the first thermal curing sub-step of thermally curing the entire of the composition layer, a problem is not caused.

In the process for producing a flexographic printing plate precursor for laser engraving of the present invention, a “ventilation efficiency” is represented by a rate at which gas in the atmosphere is ventilated per minute in an airtight container used in the curing step (2). That is, provided that an internal volume of a container (oven or the like) used in the curing step (2) is V₀ liters, and that a volume of gas supplied into and discharged from the container per minute is V₁ liters, the ventilation efficiency is represented by V₁/V₀.

The ventilation efficiency is preferably 1% by volume/min to 500% by volume/min, more preferably 10% by volume/min to 200% by volume/min, and particularly preferably 20% by volume/min to 100% by volume/min.

Ventilation operation is preferably performed under 1 atm.

The present inventor found that in a case of a film that is flexible even at room temperature, such as a relief forming layer of a flexographic printing plate, if the film is thermally cured at a temperature extremely higher than a glass transition temperature, polymerization is markedly inhibited due to oxygen in the atmosphere. Presumably, this is because when the temperature becomes extremely higher than a glass transition temperature, transfer of substances is accelerated in the film, whereby oxygen permeates the film and the influence of polymerization inhibition caused on the radical polymerizable compound by oxygen is not restricted only to the surface of the film.

The process for producing a flexographic printing plate precursor for laser engraving of the present invention can further comprise arbitrary steps in addition to the applying step (1) and curing step (2) described above. Examples of preferable arbitrary steps include a step of providing a photocurable composition layer onto the thermally cured composition, a step of pasting another light-transmissive support onto the photocurable composition layer, and a step of curing the photocurable composition with light.

Details of the arbitrary steps will be described after components of a composition for forming a relief are described.

Next, the composition applied onto a support will be described. This composition is for preparing a relief forming layer.

The composition comprises (Component A) a radical polymerizable compound and (Component B) a thermal radical polymerization initiator, as essential components. Hereinafter, Components A and B will be described, and then arbitrary components which are (Component C) a photothermal conversion agent, (Component D) a binder polymer, and (Component E) a cross-linking agent will be described in this order.

### <(Component A) Radical Polymerizable Compound>

In the process of the present invention, in order to impart a self-supporting property to the relief forming layer, or in view of optionally forming a cross-linked structure in the relief forming layer, the composition for forming a relief (also referred to as a “composition of the present invention” in the present invention) comprises (Component A) a radical polymerizable compound.

As (Component A) a radical polymerizable compound usable in the present invention, it is possible to arbitrarily select one or more kinds among compounds having at least 1, preferably 2 or more, and more preferably 2 to 6 ethylenically unsaturated bonds in a molecule.

Moreover, the composition used in the present invention preferably comprises, as (Component A) a radical polymerizable compound, a polyfunctional ethylenically unsaturated compound that has 2 or more ethylenically unsaturated groups in a single molecule. The polyfunctional ethylenically unsaturated compound is preferably a compound having 2 or more (meth)acryl groups and more preferably a compound having 2 or more (meth)acryloxy groups.

Hereinafter, monofunctional monomers having one ethylenically unsaturated bond in a molecule, and polyfunctional monomers having two or more ethylenically unsaturated bonds in a molecule employed as the radically polymerizable compound are explained.

In the resin composition formed on support, at least polyfunctional monomers are preferably used in order to form a crosslinked structure in the film. The polyfunctional monomer has preferably a molecular weight of 200 to 2,000.

Examples of the monofunctional monomers include esters of an unsaturated carboxylic acid (such as acrylic acid, methacrylic acid, itaconic acid, crotonic acid, isocrotonic acid or maleic acid) with a monovalent alcohol compound, amides of an unsaturated carboxylic acid with a monovalent amine compound, etc. Examples of the polyfunctional monomers include esters of an unsaturated carboxylic acid (such as acrylic acid, methacrylic acid, itaconic acid, crotonic acid, isocrotonic acid or maleic acid) with a polyvalent alcohol compound, amides of an unsaturated carboxylic acid with a polyvalent amine compound, etc.

Further, addition products of an unsaturated carboxylic acid ester or amide having a nucleophilic substituent such as a hydroxy group, an amino group or a mercapto group with a monofunctional or polyfunctional isocyanate or epoxy, dehydrating condensation products with a monofunctional or polyfunctional carboxylic acid, etc. are used preferably.

Examples of the polyfunctional monomers include esters of an unsaturated carboxylic acid and a polyvalent aliphatic alcohol.

Specific examples of them include, as acrylic acid esters, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetradicrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

As examples of other esters, aliphatic alcohol-based esters described in JP-B-46-27926, JP-B-51-47334 (JP-B denotes a Japanese examined patent application publication) and JP-A-57-196231, those having an aromatic skeleton described in JP-A-59-5240, JP-A-59-5241, and JP-A-2-226149, those having an amino group described in JP-A-1-165613, etc. may also be used suitably.

Furthermore, specific examples of amide monomers of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based polyfunctional ethylenically unsaturated compounds include those having a cyclohexylene structure described in JP-B-54-21726.

Furthermore, a urethane-based addition-polymerizable compound produced by an addition reaction of an isocyanate group and a hydroxy group is also suitable as a polyfunctional ethylenically unsaturated compound, and specific examples thereof include urethane-based polyfunctional ethylenically unsaturated compounds comprising two or more groups per molecule in which a hydroxy group-containing ethylenically unsaturated compound represented by Formula (A) below is added to a polyisocyanate compound having two or more isocyanate groups per molecule described in JP-B-48-41708.

CH₂═C(R)COOCH₂CH(R′)OH (A)

wherein R and R′ independently denote H or CH₃.

Furthermore, urethane acrylates described in JP-A-51-37193, JP-B-2-32293, and JP-B-2-16765, and urethane-based polyfunctional ethylenically unsaturated compounds having an ethylene oxide chain described in JP-B-58-49860, JP-B-56-17654, JP-B-62-39417, JP-B-62-39418 are also suitable.

Furthermore, by use of an addition-polymerizable compound having an amino structure or a sulfide structure in the molecule described in JP-A-63-277653, JP-A-63-260909, and JP-A-1-105238, a crosslinked resin composition can be obtained in a short time.

Other examples of polyfunctional ethylenically unsaturated compounds include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Specific examples of a radical polymerizable compound employable for the present invention include saturated bridged cyclic polyfunctional monomers.

As the saturated bridged cyclic polyfunctional monomer, the use of an alicyclic polyfunctional monomer having a condensed ring structure such as a compound having a bicyclo ring or a tricyclo ring structure having two methacryloyloxy groups or acryloyloxy groups is preferable from the viewpoint of controlling the physical properties.

Examples of the bicyclo rings or tricyclo rings include alicyclic hydrocarbon structures of a condensed ring structure such as norbornene skeleton (bicyclo[2.2.1]heptane), dicyclopentadiene skeleton (tricyclo[5.2.1.0^{2,6}]decane), adamantine skeleton (tricyclo[3.3.1.1^{3,7}]decane).

As the saturated bridged cyclic polyfunctional monomer, an amino group may be bonded to a bicyclo ring or a tricyclo ring directly, or via a aliphatic part of alkylene etc. such as methylene or ethylene. Moreover, a hydrogen atom of an alicyclic hydrocarbon group of these condensed ring structures may be substituted by an alkyl group etc.

In the present invention, the saturated bridged cyclic polyfunctional monomer is preferably an alicyclic polyfunctional monomer selected from the compounds below.

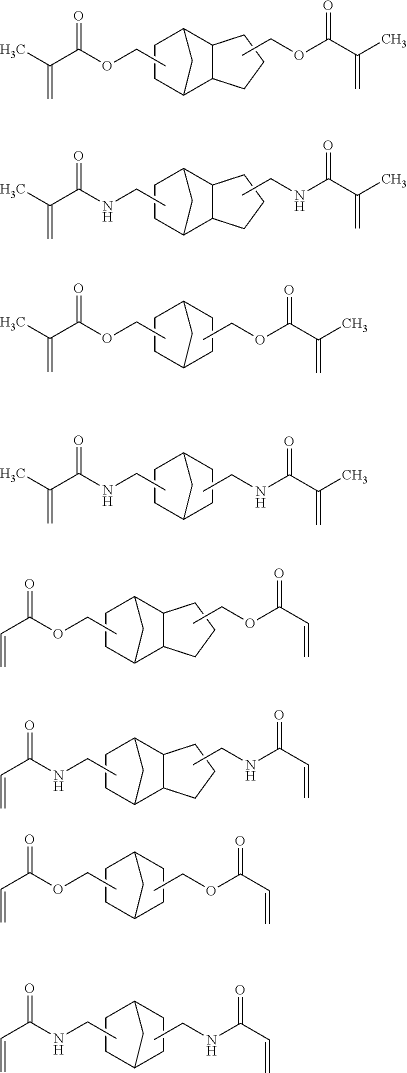

Further, as radical polymerizable compound, addition products of unsaturated carboxylic acid esters or amides having an electrophilic substituent such as an isocyanate group or an epoxy group with a monofunctional or polyfunctional alcohol, amine or thiol, and substitution products of unsaturated carboxylic acid esters or amides having a leaving substituent such as a halogeno group or a tosyloxy group with a monofunctional or polyfunctional alcohol, amine or thiol are also preferable.

In addition, as other examples, the use of compounds obtained by substituting the unsaturated carboxylic acid by an unsaturated sulfonic acid, styrene, a vinyl ether or the like is also possible.

The polymerizable compound is not particularly limited, and, in addition to compounds exemplified above, various known compounds may be used. For example, compounds described in JP-A-2009-204962, paragraphs 0098 to 0124 may be used.

From the viewpoint of improving engraving sensitivity, it is preferable in the present invention to use as the radical polymerizable compound having an ethylenically unsaturated group a compound having a sulfur atom in the molecule.

As such an radical polymerizable compound having a sulfur atom in the molecule, it is preferable from the viewpoint of improving engraving sensitivity in particular to use a polymerizable compound having two or more ethylenically unsaturated bonds and having a carbon-sulfur bond at a site where two ethylenically unsaturated bonds among them are linked (hereinafter, called a ‘sulfur-containing polyfunctional monomer’ as appropriate).

Examples of carbon-sulfur bond-containing functional groups of the sulfur-containing polyfunctional monomer in the present invention include sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, and thiourea-containing functional groups.

Furthermore, a linking group containing a carbon-sulfur bond linking two ethylenically unsaturated bonds of the sulfur-containing polyfunctional monomer is preferably at least one unit selected from —C—S—, —C—S—S—, —NH(C═S)O—, —NH(C═O)S—, —NH(C═S)S—, and —C—SO₂—.

Moreover, the number of sulfur atoms contained in the sulfur-containing polyfunctional monomer molecule is not particularly limited as long as it is one or more, and may be selected as appropriate according to the intended application, but from the viewpoint of a balance between engraving sensitivity and solubility in a coating solvent it is preferably 1 to 10, more preferably 1 to 5, and yet more preferably 1 or 2.

On the other hand, the number of ethylenically unsaturated bond sites contained in the molecule is not particularly limited as long as it is two or more and may be selected as appropriate according to the intended application, but from the viewpoint of flexibility of a crosslinked film it is preferably 2 to 10, more preferably 2 to 6, and yet more preferably 2 to 4.

From the viewpoint of flexibility of a film that is formed, the molecular weight of the sulfur-containing polyfunctional monomer in the present invention is preferably 120 to 3,000, and more preferably 120 to 1,500.

Furthermore, the sulfur-containing polyfunctional monomer in the present invention may be used on its own or as a mixture with a polyfunctional polymerizable compound or monofunctional polymerizable compound having no sulfur atom in the molecule.

Moreover, examples of the polymerizable compound having a sulfur atom in the molecule include those described in paragraphs 0032 to 0037 of JP-A-2009-255510.

Component A in the resin composition of the present invention may be used singly or in a combination of two or more compounds.

The content of Component A contained in the resin composition of the present invention is preferably 2 to 50 wt % on a solids content basis, more preferably is 5 to 30 wt %, and most preferably is 10 to 20 wt %.

### <(Component B) Radical Thermal Polymerization Initiator>

The composition for coating in the present invention comprises (Component B) a radical thermal polymerization initiator as essential component.

With regard to the polymerization initiator, one known to a person skilled in the art may be used without any limitations, but is preferably a radical polymerization initiator.

Radical thermal polymerization initiators, which are preferred radical thermal polymerization initiators, are explained in detail below, but the present invention should not be construed as being limited to these descriptions.

In the present invention, preferred examples of the radical polymerization initiator include (a) an aromatic ketone, (b) an onium salt compound, (c) an organic peroxide, (d) a thio compound, (e) a hexaarylbiimidazole compound, (f) a ketoxime ester compound, (g) a borate compound, (h) an azinium compound, (i) a metallocene compound, (j) an active ester compound, (k) a compound having a carbon halogen bond, and (l) an azo-based compound.

Specific examples of the (a) to (l) above are shown below, but the present invention is not limited to these.

In the present invention, (c) an organic peroxide and (I) an azo-based compound is preferable, and (c) an organic peroxide is particurally preferable from the viewpoint of curability of the coated composition. These initiators are explained below.

### (c) Organic Peroxides

Preferable as the radical thermo polymerization initiator which can be used in the present invention is preferably ether peoxide such as 3,3′,4,4′-tetra(tertiarybutylperoxycarbonyl)benzophenone, 3,3′,4,4′-tetra(tertiaryamylperoxycarbonyl)benzophenone, 3,3′,4,4′-tetra(tertiaryhexylperoxycarbonyl)benzophenone, 3,3′,4,4′-tetra(tertiaryoctylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-tertiarybutyldiperoxy isophthalate, tertiarybutylperoxy benzoate etc.

### (l) Azo-Based Compound

Preferable (l) azo-based compounds used as the radical thermo polymerization initiator in the present invention include 2,2′-azobisisobutyronitrile, 2,2′-azobispropionitrile, 1,1′-azobis(cyclohexane-1-carbonitrile), 2,2’-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), 2,2′-dimethyl azobisisobutyrate, 2,2′-azobis(2-methylpropionamidoxime), 2,2′-azobis[2-(2-imidazoline-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], and 2,2′-azobis(2,4,4-trimethylpentane), etc.

In the present invention, the above-mentioned (c) organic peroxide is preferable as the polymerization initiator in the present invention from the viewpoint of the crosslinking properties of the film (relief-forming layer), and particularly preferable from the viewpoint of improving the engraving sensitivity.

In the present invention, the above-mentioned (c) organic peroxide is preferable as the polymerization initiator in the present invention from the viewpoint of improving the engraving sensitivity of cured film, which is relied forming layer.

From the viewpoint of the engraving sensitivity, an embodiment obtained by combining (c) an organic peroxide and a binder polymer having a glass transition temperature of ordinary temperature (20° C.) or more as (Component D) a binder polymer described below is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the radiated laser energy to thus raise the engraving sensitivity.

It is presumed that, in the case where the glass transition temperature of the binder polymer is ordinary temperature (20° C.) or more, the heat generated caused by the decomposition of the organic peroxide is transmitted effectively to the binder polymer and utilized effectively to the thermal decomposition of the binder polymer itself to thus make the sensitivity more higher.

It will be described in detail in the explanation of (Component C) a light-heat converting agent, the effect thereof is remarkable when carbon black is used as the light-heat converting agent. It is considered that the heat generated from the carbon black is also transmitted to (c) an organic peroxide and, as the result, heat is generated not only from the carbon black but also from the organic peroxide, and that the generation of heat energy to be used for the decomposition of the binder polymer etc. occurs synergistically.

Further, as a component to be preferably combined, the use of the organic peroxide and the light-heat converting agent to be described later in combination causes the engraving sensitivity to be raised extremely, more preferably, and an embodiment that uses the organic peroxide and carbon black as the light-heat converting agent in combination is most preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, an energy of generated heat is added to the radiated laser energy to thus raise the engraving sensitivity.

Component B in the composition of the present invention may be used singly or in a combination of two or more compounds.

The content of Component B in the composition of the present invention is preferably 0.1 to 5 wt % relative to the total weight of the solids content, more preferably 0.3 to 3 wt %, particuraly preferably 0.5 to 1.5 wt %.

The composition used in the present invention can comprise, as an arbitrary component, at least one component among (Component C) a photothermal conversion agent, (Component D) a binder polymer, and (Component E) a cross-linking agent. The composition preferably comprises two or more kinds of the arbitrary component, and more preferably comprises all of the three components.

### <(Component C) Photothermal Conversion Agent>

The composition for laser engraving of the present invention preferably further comprises (Component C) photothermal conversion agent.

It is surmised that the photothermal conversion agent absorbs laser light and generates heat thus promoting thermal decomposition of a cured material of the resin composition for laser engraving of the present invention. Because of this, it is preferable to select a photothermal conversion agent that absorbs light having the wavelength of the laser that is used for engraving.

When a flexographic printing plate precursor for laser engraving produced by the process of the present invention is engraved by lasers, a laser (a YAG laser, a semiconductor laser, a fiber laser, a surface emitting laser, etc.) emitting infrared at a wavelength of 700 to 1,300 nm is used as a light source, and it is preferable for the relief-forming layer in the present invention to comprise a photothermal conversion agent that can absorb light having a wavelength of 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples preferably include dyes having a maximum absorption wavelength at 700 to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. Examples of dyes that can be used in the present invention include cyanine-based dyes such as heptamethine cyanine dyes, oxonol-based dyes such as pentamethine oxonol dyes, phthalocyanine-based dyes, and dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples include pigments described in paragraphs 0122 to 0125 of JP-A-2009-178869. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples include carbon blacks described in paragraphs 0130 to 0134 of JP-A-2009-178869.

Component C in the composition of the present invention may be used singly or in a combination of two or more compounds.

The content of the photothermal conversion agent in the resin composition for laser engraving of the present invention largely depends on the size of the molecular extinction coefficient characteristic to the molecule, and is preferably 0.01 to 30 wt % relative to the solid total weight of the composition, more preferably 0.05 to 20 wt %, and yet more preferably 0.1 to 10 wt %.

### <(Component D) Binder Polymer>

The composition useful for the present invention preferably comprises (Component D) a binder polymer.

A binder polymer is a polymer component contained in resin composition for raser engraving.

The number-average molecular weight (Mn) of the binder polymer is preferably 500 to 5,000,000.

The weight-average molecular weight (In polystyrene equivalent by GPC measurement) of the binder polymer is preferably less than 1,000, more preferably is 5,000 to 5,000,000, yet more preferably is 10,000 to 4,000,000, and particularly preferably is 150,000 to 3,000,000.

Examples of binder is a polystyrene resin, polyester resin, polyamide resin, polyurea resin, polyamide imide resin, polyurethane resin, polysulfone resin, polyether sulfone resin, polyimide resin, polycarbonate resin, hydroxyethylene unit-containing hydrophilic polymer, acrylic resin, acetal resin, epoxy resin, polycarbonate resin, rubber, thermoplastic elastomer, etc.

The binder polymer usable in the present invention preferably has film formability.

In addition, the binder polymer preferably is cross-linkable, and more preferably has a functional group contributing to a cross-linking reaction. Examples of such an active group include a hydroxyl group which can be cross-linked to an alkoxy group, a hydrolyzable silyl group, and a silanol group.

These functional groups may be present anywhere in a polymer molecule, but they are particularly preferably present on a side chain of a polymer chain. As such a polymer, a vinyl copolymer (a copolymer of vinyl monomers such as polyvinyl alcohol or polyvinyl acetal and a derivative thereof) or an acrylic resin (a copolymer of acrylic monomers such as hydroxyethyl(meth)acrylate and a derivative thereof) is preferably used. Here, the derivative of a copolymer of vinyl monomers specifically refers to a binder polymer that is obtained by forming a structure in which a side chain is extended by chemically modifying a hydroxyl group or an α-position of a hydroxyl group of a vinyl alcohol unit, and introducing a functional group such as a hydroxyl group or a carboxyl group to the end of the structure. Examples of the derivative of a copolymer of acrylic monomers include a resin obtained by introducing a functional group such as a hydroxyl group or a carboxyl group.

The process for producing a binder polymer usable in the present invention is not particularly limited, and examples thereof include a process for producing the binder polymer by polymerizing or copolymerizing polymerizable monomers.

As the binder polymer usable in the present invention, a binder polymer having a hydroxyl group is particularly preferable, and examples thereof include polyvinyl butyral.

Component D is added preferably in a range of from 20% by weight to 90% by weight, and more preferably in a range of from 30% by weight to 85% by weight, based on the amount of the total solid content of the composition of the present invention.

### <(Component E) Cross-Linking Agent>

The composition used for the relief forming layer preferably further comprises (Component E) a cross-linking agent.

(Component E) a cross-linking agent is a component other than Component A and preferably a compound that causes cross-linking by a sequential reaction. (Component E) a cross-linking agent preferably has a polyaddition type or a polycondensation type component.

Specifically, (Component E) a cross-linking agent is preferably one kind selected from a group consisting of (Component E1) a polyfunctional isocyanate compound, (Component E2) a polyfunctional acid anhydride, and (Component E3) a polyalkoxysilane compound.

Components E1, E2, and E3 described above will be described below in order. Among these cross-linking agents, Component E3 is preferable.

### <(Component E1) Polyfunctional Isocyanate Compound>

A “polyfunctional isocyanate compound” refers to a compound that has at least 2 or more isocyanate groups in a molecule.

(Component E1) a polyfunctional isocyanate group used in the present invention has 2 or more isocyanate groups in its molecule. In view of forming a three-dimensional cross-linked structure, the number of isocyanate groups is preferably 2 to 10, more preferably 2 to 6, and particularly preferably 2 to 4.

Hereinafter, (Component E1) a polyfunctional isocyanate compound will be described.

Examples of compound having 2 isocyanate groups in a molecule include m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-dimethoxy-biphenyl diisocyanate, 3,3′-dimethyldiphenylmethane-4,4′-diisocyanate, xylylene-1,4-diisocyanate, xylylene-1,3-diisocyanate, 4-chloroxylylene-1,3-diisocyanate, 2-methylxylylene-1,3-diisocyanate, 4,4′-diphenylpropane diisocyanate, 4,4′-diphenylhexafluoropropane diisocyanate, trimethylene diisocyanate, hexamethylene diisocyanate, propylene-1,2-diisocyanate, butylene-1,2-diisocyanate, cyclohexylene-1,2-diisocyanate, cyclohexylene-1,3-diisocyanate, cyclohexylene-1,4-diisocyanate, dicyclohexylmethane-4,4′-diisocyanate, 1,4-bis(isocyanatomethyl)cyclohexane, 1,3-bis(isocyanatomethyl)cyclohexane, isophorone diisocyanate, lysine diisocyanate, and the like. Moreover, products of an addition reaction between these bifunctional isocyanate compounds and bifunctional alcohols or phenols such as ethylene glycols or bisphenols can also be used.

In addition, other polyfunctional isocyanate compounds can also be used. Examples of such compounds include compounds that become polyfunctional by using the bifunctional isocyanate compounds described above as a main material and adding a trimer (biuret or isocyanurate) thereof or polyol such as trimethylolpropane to the bifunctional isocyanate compound, a formalin condensate of benzene isocyanate, a polymer of an isocyanate compound having a polymerizable group such as methacryloyloxyethyl isocyanate, lysine triisocyanate, and the like.

Particularly, compounds which become polyfunctional in the form of an adduct obtained by using xylene isocyanate and a hydrogenated product thereof, hexamethylene diisocyanate, or tolylene diisocyanate and a hydrogenated product thereof as a main material and combining the material with a trimer (biuret or isocyanurate) thereof or trimethylolpropane are preferable. These compounds are described in “Polyurethane Resin Handbook” (edited by Keiji IWATA, published by THE NIKKAN KOGYO SIMBUN, LTD. (1987)).

Among these, 2,4-tolylene diisocyanate, 2,6-tolylene diisocyanate, xylylene-1,4-diisocyanate, xylylene-1,3-diisocyanate, and adducts of trimethylolpropane with xylylene-1,4-diisocyanate or xylylene-1,3-diisocyanate are preferable, and xylylene-1,4-diisocyanate, xylylene-1,3-diisocyanate, and adducts of trimethylolpropane with xylylene-1,4-diisocyanate or xylylene-1,3-diisocyanate are particularly preferable.

In view of engraving sensitivity, (Component E1) a polyfunctional isocyanate compound preferably has a hetero atom such as nitrogen, oxygen, or sulfur in a site where two isocyanate groups are linked, and more preferably has a carbon-sulfur bond.

More specifically, a linking group having the carbon-sulfur bond is preferably at least one unit (atomic group) selected from —CH₂—S—, —CH₂—SS—, —NHC(═S))—, —NH(C═O)S—, —NH(C═S)S—, and —CH₂—SO₂—. Among these, in view of improving engraving sensitivity, —CH₂—SS—, —NH(C═S)O—, —NH(C═O)S—, and —NH(C═S)S— are preferable, and —CH₂—SS— and —NH(C═O)S— are most preferable.

(Component E1) a polyfunctional isocyanate compound preferably has a carbon-sulfur bond in a site where two isocyanate groups are linked. The number of sulfur atoms included in a molecule is not particularly limited so long as the number is 1 or more, and can be appropriately selected according to the purpose. However, in view of balance between engraving sensitivity and solubility in a coating solvent, the number is preferably 1 to 10, more preferably 1 to 5, and particularly preferably 1 to 2.

The sulfur-containing isocyanate that contains sulfur atoms in a molecule can be synthesized by an addition reaction between a sulfur-containing polyfunctional alcohol, a sulfur-containing polyfunctional amine, or a polyfunctional thiol and a polyfunctional isocyanate.

Specific examples of (Component E1) a polyfunctional isocyanate compound will be shown below, but the present invention is not limited thereto.

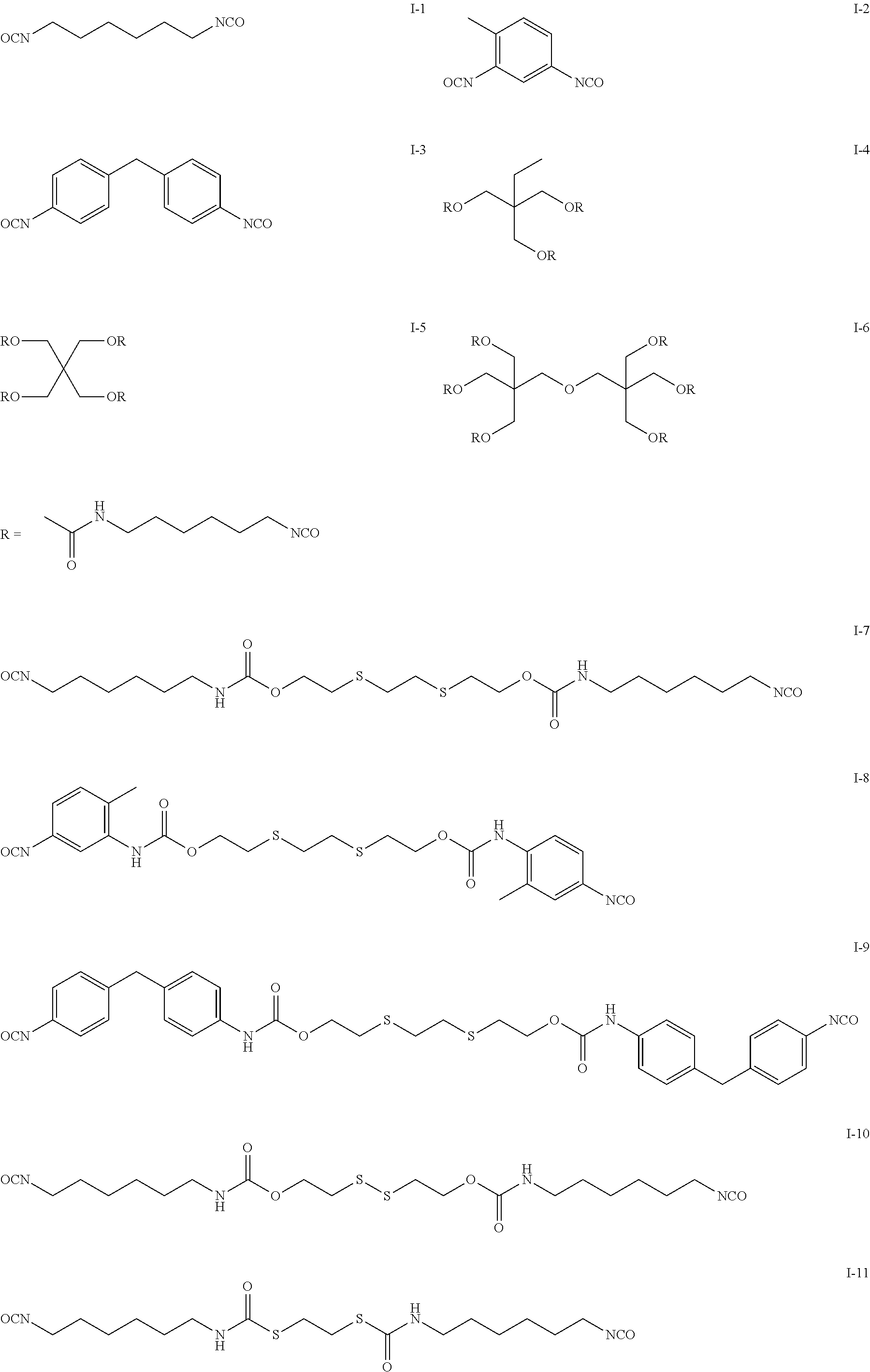

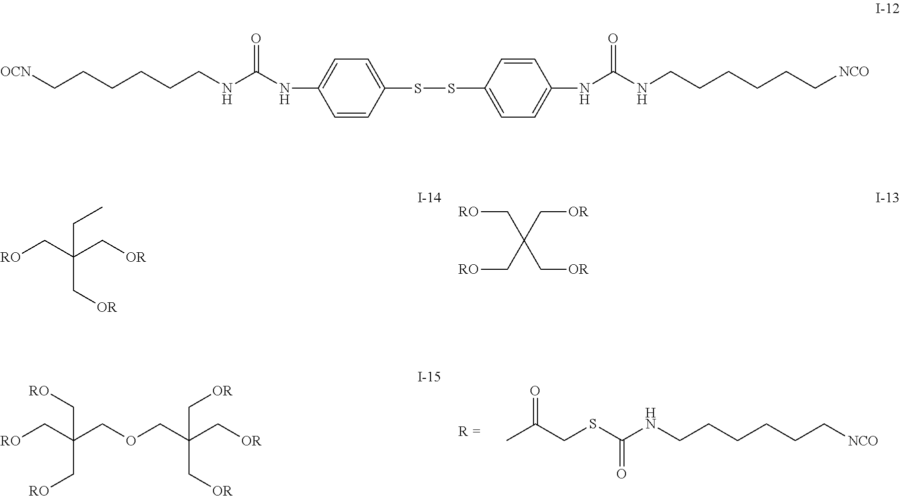

Among the above specific examples of (Component E1) a polyfunctional isocyanate compound, in view of improving engraving sensitivity, compounds I-7 to I-15 are preferable, compounds I-7, I-8, I-10, I-11, I-12, and I-13 are more preferable, and compounds I-7, I-10, and I-11 are particularly preferable.

The molecular weight of (Component E1) a polyfunctional isocyanate compound is preferably 100 to 5,000 and more preferably 150 to 3,000, in view of the flexibility of the formed cross-linked relief forming layer.

The amount of (Component E1) a polyfunctional isocyanate compound added preferably ranges from 0.1% by weight to 80% by weight, more preferably ranges from 1% by weight to 40% by weight, and even more preferably ranges from 5% by weight to 30% by weight, in the total solid content of the composition for forming a relief layer.

### <(Component E2) Polyfunctional Acid Anhydride>

A polyfunctional acid anhydride refers to a compound having 2 or more dibasic acid anhydride structures in a molecule.

Any type of polyfunctional acid anhydride can be used as (Component E2) a polyfunctional acid anhydride so long as it is a compound having 2 or more acid anhydride structures such as carboxylic anhydride residues in a molecule. That is, any compound having 2 or more chemical structures as above in a molecule forms an excellent cross-linked structure with a functional group such as a hydroxyl group.

The dibasic acid anhydride structure in (Component E2) a polyfunctional acid anhydride refers to an anhydride structure that is formed by dehydration condensation of 2 carboxylic acids present in the same molecule.

In view of rinsing properties, the number of the carboxylic anhydride structures present in a molecule is preferably from 2 to 4, more preferably from 2 to 3 and most preferably 2.

Examples of compounds having 2 carboxylic anhydride structures suitably used in the present invention include tetrabasic acid dianhydrides. Specific examples of the tetrabasic acid dianhydride include aliphatic or aromatic tetracarboxylic acid dianhydrides such as biphenyl tetracarboxylic dianhydride, naphthalene tetracarboxylic dianhydride, diphenylether tetracarboxylic dianhydride, butane tetracarboxylic dianhydride, cyclopentane tetracarboxylic dianhydride, pyromellitic dianhydride, benzophenone tetracarboxylic dianhydride, and pyridine tetracarboxylic dianhydride. Examples of compounds having three carboxylic anhydride structures include mellitic trianhydrides, and the like.

The molecular weight of (Component E2) a polyfunctional acid anhydride is preferably greater than or equal to 80 and less than 500.

Hereinafter, specific examples of (Component E2) a polyfunctional acid anhydride suitably used in the present invention will be shown as specific compounds A-1 to A-7, but the present invention is not limited thereto.

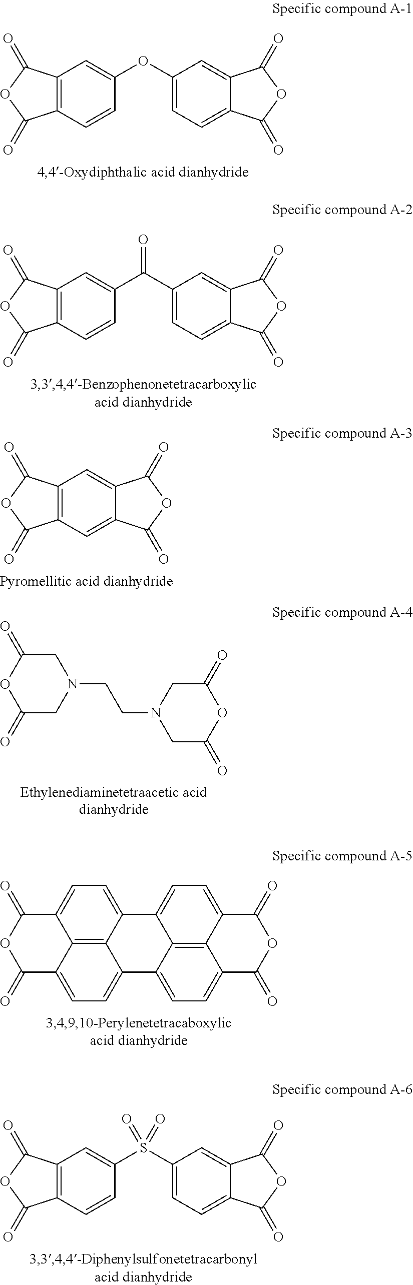 [SMILES: O=C1OC(=O)c2cc(Oc3ccc4c(c3)C(=O)OC4=O)ccc21 ; O=C(c1ccc2c(c1)C(=O)OC2=O)c1ccc2c(c1)C(=O)OC2=O ; O=c1oc(=O)c2cc3c(=O)oc(=O)c3cc12 ; O=C1CN(CCN2CC(=O)OC(=O)C2)CC(=O)O1 ; O=C1OC(=O)c2ccc3c4ccc5c6c(ccc(c7ccc1c2c73)c64)C(=O)OC5=O ; O=C1OC(=O)c2cc(S(=O)(=O)c3ccc4c(c3)C(=O)OC4=O)ccc21]

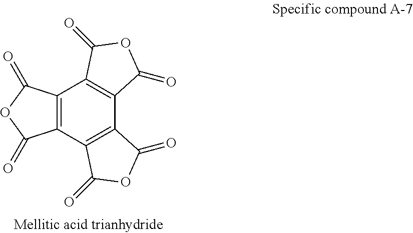 [SMILES: O=c1oc(=O)c2c1c1c(=O)oc(=O)c1c1c(=O)oc(=O)c21]

In the present invention, one kind of (Component E2) a polyfunctional acid anhydride may be used alone, or two or more kinds thereof may be used in combination.

The amount of (Component E2) a polyfunctional acid anhydride included in the composition for forming a relief forming layer that is used for forming a cross-linked relief forming layer preferably ranges from 1% by weight to 30% by weight, more preferably ranges from 3% by weight to 30% by weight, and particularly preferably ranges from 5% by weight to 30% by weight, in terms of solid content.

### <(Component E3) Polyalkoxysilane Compound>

A “polyalkoxysilane compound” refers to a compound that has at least 2 alkoxysilyl groups in a single molecule.

(Component E3) a polyalkoxysilane compound that can be mixed into the composition for forming a relief forming layer of the present invention has a plurality of hydrolyzable silyl groups in a single molecule.

Examples of hydrolyzable groups include an alkoxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or silanol group (hereinafter called as an ‘alkoxysilyl compound’ as appropriate ) is preferably one represented by Formula (1) below.

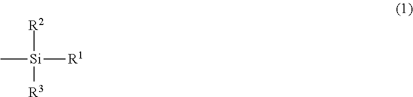

wherein at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group, and the remainder of R¹ to R³ independently denote a hydrogen atom, a halogen atom, or a monovalent organic substituent (examples including an alkyl group, an aryl group, an alkenyl group, an alkynyl group, and an aralkyl group).

In Formula (1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

Component E3 in the present invention is preferably a compound having one or more residue represented by Formula (1) above, and more preferably a compound having two or more. A polyalkoxysilyl compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in Component E3 is preferably at least 2 but no greater than 6, and most preferably 2 or 3.

A range of 1 to 4 of the hydrolyzable groups may bond to one silicon atom, and the total number of hydrolyzable groups in Formula (1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

Component E3 preferably has at least a sulfur atom, an ester bond, a urethane bond, an ether bond, a urea bond, or an imino group.

Among them, from the viewpoint of crosslinkability, Component E3 preferably comprises a sulfur atom, and from the viewpoint of removability (rinsing properties) of engraving residue it is preferable for it to comprise an ester bond, a urethane bond, or an ether bond (in particular, an ether bond contained in an oxyalkylene group), which are easily decomposed by aqueous alkali. Component E3 containing a sulfur atom functions as a vulcanizing agent or a vulcanization accelerator at the time of vulcanization treatment, and accelerates the reaction (crosslinking) of the polymer containing a conjugated diene monomer unit used as (Component D) a binder polymer. As a result, Component E3 exhibits rubber elasticity that is needed as a flexographic printing plate. Also, Component E3 enhances the strength of the crosslinked relief-forming layer and the relief layer.

Furthermore, Component E3 according to the present invention is preferably a compound which does not have an ethylenically unsaturated bond.

Component E3 useful in the present invention is known, and specific examples are shown below. Examples thereof include vinyltrichlorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, p-styryltrimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, mercaptomethyltrimethoxysilane, dimethoxy-3-mercaptopropylmethylsilane, 2-(2-aminoethylthioethyl)diethoxymethylsilane, 3-(2-acetoxyethylthiopropyl)dimethoxymethylsilane, 2-(2-aminoethylthioethyl)triethoxysilane, dimethoxymethyl-3-(3-phenoxypropylthiopropyl)silane, bis(triethoxysilylpropyl)disulfide, bis(triethoxysilylpropyl) tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-ureidopropyltriethoxysilane, trimethylsilanol, diphenylsilanediol, triphenylsilanol, methyltrimethoxysilane, methyltriethoxysilane, phenyltrimethoxysilane, phenyltriethoxysilane, dimethyldimethoxysilane, dimethyldiethoxysilane, diphenyltrimethoxysilane, and diphenyltriethoxysilane, Other than the above, the compounds shown below can be cited as preferred examples, but the present invention should not be construed as being limited thereto. The procedure for the synthesis of Component E3 is not particularly limited, and any known procedure can be employed.

The amount of Component E3 added preferably ranges from 0.1% by weight to 30% by weight, more preferably ranges from 1% by weight to 20% by weight, and even more preferably ranges from 5% by weight to 15% by weight, in the total solid content of the composition for forming a relief layer.

Other arbitrary components that can be used for the composition of the present invention in addition to the arbitrary Components C to E described above will be described below.

### <(Component F) Plasticizer>

The composition of the present invention preferably contains a plasticizer.

A plasticizer is an agent having an action of making a film formed of a composition for laser engraving flexible, and needs to be excellently compatible with a binder polymer.

As the plasticizer, for example, dioctyl phthalate, didodecyl phthalate, bisbutoxyethyl adipate, polyethylene glycols, polypropylene glycol (monol type or diol type), and the like are preferably used.

Among these, bisbutoxyethyl adipate is particularly preferable.

In the composition of the present invention, one kind of Component F may be used alone, or two or more kinds thereof may be used in combination.

In view of maintaining physical properties of a flexible film, the amount of the plasticizer included in the composition for laser engraving of the present invention is preferably 1% by weight to 50% by weight, more preferably 5% by weight to 40% by weight, and particularly preferably 10% by weight to 30% by weight of the concentration of the total solid content.

### <(Component G) Solvent>

A solvent is preferably used when preparing a coating composition in the present invention. As solvent is preferably an organic solvent.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol. Among them, propylene glycol monomethyl ether acetate is particularly preferable.

The amount of Component G added can be appropriately selected, and is set such that the viscosity of the composition becomes appropriate at the time of application. In order to reduce a load of drying after application, it is preferable that the amount of Component G not be unnecessarily large. In the composition of the present invention, the concentration of the total solid content is preferably 50% by weight to 90% by weight, and more preferably 55% by weight to 80% by weight.

### Other Additives

The composition for a relief-forming layer that can be used in the present invention may comprise as appropriate various types of known additives as long as the effects of the present invention are not inhibited. Examples include a filler, a wax, a process oil, an organic acid, a metal oxide, an antiozonant, an anti-aging agent, a polymerization inhibitor, and a colorant, and one type thereof may be used on its own or two or more types may be used in combination.

As described above, in the process for producing a flexographic printing plate precursor for laser engraving of the present invention, the curing step (2) preferably includes the first thermal curing sub-step of thermally curing at least a portion of the composition layer obtained by application and the second thermal curing sub-step of further thermally curing the entire of the composition layer. Here, in the first thermal curing sub-step, thermal curing of the entire of the composition layer is not necessarily excluded.

The heating temperature of both the first and second thermal curing sub-steps is preferably 60° C. to 200° C., more preferably 60° C. to 150° C., and even more preferably 75° C. to 130° C.

In the first thermal curing sub-step, an oxygen partial pressure of the atmosphere is preferably set to 0.1 atm or less, more preferably set to 0.05 atm or less, and even more preferably set to 0.001 atm to 0.05 atm. The heating temperature in this sub-step is preferably set to 80° C. to 140° C., and more preferably set to 85° C. to 130° C.

In the first thermal curing sub-step, a holding period is preferably 10 to 600 minutes, more preferably 15 to 150 minutes and particularly preferably 20 to 90 minutes.

In the second thermal curing sub-step, a holding period is preferably 20 to 1,000 minutes, more preferably 30 to 500 minutes and particularly preferably 40 to 250 minutes.

Presumably, in the composition which is placed in an atmosphere of reduced pressure in the first thermal curing sub-step after being applied as a layer under atmospheric pressure, oxygen is still diffused into the composition from the surface thereof, so an area which is not completely thermally cured (soft film area) is formed in the surface side (atmosphere side) in the composition layer. This thermal curing may proceed in at least a portion of the support side, and also includes a case where curing has proceeded throughout the layer in the thickness direction. In the first thermal curing sub-step, it is preferable to ventilate the curing atmosphere.

The second thermal curing sub-step will be described. In view of cost, the second thermal curing sub-step is preferably a curing step performed in an atmosphere (where oxygen partial pressure is 0.21 atm) of atmospheric pressure (1 atm). Here, in the second thermal curing sub-step, it is preferable to ventilate the curing atmosphere similarly to the first thermal curing sub-step, and preferable ventilation conditions are also the same. The heating temperature is preferably 70° C. to 140° C., and more preferably 70° C. to 110° C.

The degree of thermal curing in the depth (thickness) direction of the composition layer can be measured from a cross-sectional hardness distribution that is obtained by local measurement performed on a cross-section of the recording layer in the thickness direction by using a micro-hardness tester (HMV-1, manufactured by Shimadzu Corporation).

The process for producing a flexographic printing plate precursor for laser engraving of the present invention preferably includes a pasting step of providing a photocurable composition (also referred to as a “photocurable adhesive”) in a form of layer onto a surface opposite to the support side of the recording layer and pasting another support onto the layer. Specifically, in addition to the two essential steps of the applying step (1) and the curing step (2), the process preferably further includes a step of providing a photocurable composition layer onto the surface of the thermally cured composition, a step of pasting another light-transmissive support onto the photocurable composition layer, and a step of curing the photocurable composition with light, in this order.

### <Pasting Step>

The process for producing a flexographic printing plate precursor for laser engraving of the present invention preferably further includes a step of providing a photocurable composition layer onto the surface of the thermally cured composition, a step of pasting another light-transmissive support onto the photocurable composition layer, and a step of curing the photocurable composition with light, in addition to the applying step (1) and the curing step (2).

In other words, the process includes a pasting step of providing a photocurable adhesive layer onto the surface opposite to the support side of the recording layer for laser engraving in the layer forming step described above and pasting another support onto the photocurable adhesive layer.

Herein, the “photocurable composition” refers to a composition having a property of being cured by ultraviolet irradiation, and preferably comprises an addition polymerizable ethylenically unsaturated compound and a photopolymerization initiator as essential components. The average thickness of the photocurable composition layer is preferably 0.05 mm to 0.2 mm, and more preferably 0.08 mm to 0.15 mm.

The photocurable adhesive more preferably comprises a (meth)acrylate compound having a hydroxyl group, a (meth)acrylate not having a hydroxyl group, and a photopolymerization initiator.

The photocurable adhesive may comprise known additives other than the above components. However, the photocurable adhesive preferably does not comprise volatile organic compounds (VOC) not having an ethylenically unsaturated group, such as an organic solvent, and more preferably comprises only a (meth)acrylate compound having a hydroxyl group, a (meth)acrylate compound not having a hydroxyl group, and a photopolymerization initiator.

In the pasting step, it is important to provide a specific photocurable adhesive onto a so-called air surface which is a surface opposite to the surface of the support side of the recording layer in the layer forming step. If this embodiment is employed, a flexographic printing plate precursor excellent in adhesiveness and uniformity of film thickness is obtained.

In the pasting step, the method of providing a photocurable adhesive onto the recording layer is not particularly limited, and known methods can be used.

### Support

This support is a support different from the support used in the applying step (1).

Here, the material of this support can be selected from those used in the applying step (1), so repetitious description will be omitted.

The support used in the pasting step is preferably a transparent support and more preferably a PET film. The thickness of the film can be selected arbitrarily, but the thickness is preferably 0.1 mm to 0.5 mm.

### (Meth)acrylate Compound Having Hydroxyl Group

The above photocurable adhesive preferably comprises a (meth)acrylate compound having a hydroxyl group.

The (meth)acrylate compound having a hydroxyl group is not particularly limited as long as the compound has at least a hydroxyl group and a (meth)acryloyl group. However, the compound is preferably a monofunctional (meth)acrylate compound having a hydroxyl group, and more preferably a compound represented by the following Formula (A). In the present invention, the term “(meth)acryl” includes either or both of “acryl” and “methacryl”, and this is applied to the terms “(meth)acrylate” and “(meth)acryloyl” in the same manner.

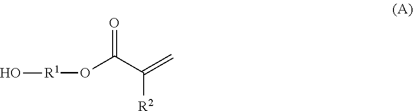

wherein R¹ represents an alkylene group, which preferably has 2 to 20 carbon atoms and more preferably has 2 to 10 carbon atoms.

The alkylene group represented by R¹ may be linear or branched, or may have a cyclic structure. In addition, the alkylene group represented by R¹ may have a substituent. Preferable examples of the substituent include a halogen atom, a hydroxy group, an alkoxy group, an aryl group, and an aryloxy group.

In Formula (A), R² represents a hydrogen atom or a methyl group.

Specific examples of the (meth)acrylate compound having a hydroxyl group include 2-hydroxyethyl(meth)acrylate, 2-hydroxypropyl(meth)acrylate, hydroxybutyl(meth)acrylate, hydroxyhexyl(meth)acrylate, hydroxyoctyl(meth)acrylate, 3-hydroxy-2-phenoxypropyl(meth)acrylate, 2-hydroxy-3-chloropropyl(meth)acrylate, diglycerol di(meth)acrylate, 2-hydroxy-3-phenoxypropyl(meth)acrylate, cyclohexanoxy-β-hydroxypropyl(meth)acrylate, tetrahydrofurfuroxy-β-hydroxypropyl(meth)acrylate, nonyloxy-β-hydroxypropyl(meth)acrylate, and the like.

One kind of the (meth)acrylate compound having a hydroxyl group may be used alone, or two or more kinds thereof may be used in combination. The amount of the (meth)acrylate compound having a hydroxyl group included in the photocurable adhesive is preferably 10 parts by weight to 80 parts by weight, and more preferably 20 parts by weight to 65 parts by weight, based on 100 parts by weight of the photocurable adhesive.

### (Meth)acrylate Compound Not Having Hydroxyl Group

The photocurable adhesive comprises a (meth)acrylate compound not having a hydroxyl group, in addition to the (meth)acrylate compound having a hydroxyl group.

The (meth)acrylate compound not having a hydroxyl group is not particularly limited as long as this compound does not have a hydroxyl group. The photocurable adhesive preferably comprises at least a polyfunctional (meth)acrylate compound not having a hydroxyl group.

Preferable examples of the (meth)acrylate compound not having a hydroxyl group include the following compounds represented by Formulae (B-1) to (B-7).

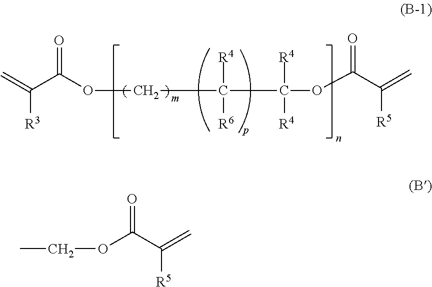

In Formula (B-1), R³ represents a hydrogen atom or —CH₃; R⁴s each independently represent a hydrogen atom, —CH₃, —C₂H₅, or a group represented by Formula (B′); R⁵s each independently represent a hydrogen atom, a chlorine atom, —CH₃ or —C₂H₅; R⁶s each independently represent a hydrogen atom or a group represented by Formula (B′); m's each independently represent an integer from 1 to 8; n represents an integer from 1 to 20; and p′s each independently represent 0 or 1.

Specific examples of the compound represented by Formula (B-1) include diethylene glycol di(meth)acrylate, triethylene glycol di(meth)acrylate, tetraethylene glycol di(meth)acrylate, 1,2-propylene glycol di(meth)acrylate, dipropylene glycol di(meth)acrylate, polyethylene glycol di(meth)acrylate, glycerin tri(meth)acrylate, trimethylolpropane tri(meth)acrylate, and diglycerol tetra(meth)acrylate.

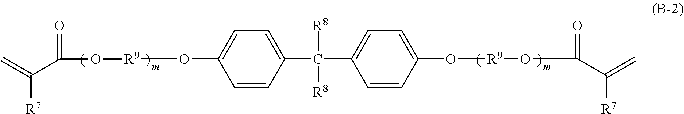

In Formula (B-2), R⁷s each independently represent a hydrogen atom or —CH₃; R⁸s each independently represent a hydrogen atom or a linear or branched alkyl group having 1 to 4 carbon atoms; R⁹s each independently represent a linear or branched alkylene group having 2 to 4 carbon atoms; and m′s each independently represent an integer from 1 to 10.

Specific examples of the compound represented by Formula (B-2) include 2,2-bis(4-methacryloxydiethoxyphenyl)propane, 2,2-bis(4-methacryloxytriethoxyphenyl)propane, 2,2-bis(4-acryloxypentaethoxyphenyl)propane, 2,2-bis(4-methacryloxyhexaethoxyphenyl)propane, 2,2-bis(4-acryloxyheptaethoxyphenyl)propane, 2,2-bis(4-methacryloxyoctaethoxyphenyl)propane, 2,2-bis(4-acryloxydipropoxyphenyl)propane, 2,2-bis(4-methacryloxytripropoxyphenyl)propane, 2,2-bis(4-acryloxydibutyoxyphenyl)propane, 2,2-bis(4-methacryloxyoctadibutoxyphenyl)propane, 2-(4-methacryloxydiethoxyphenyl)-2-(4-methacryloxytriethoxyphenyl)propane, and 2-(4-acryloxydipropoxyphenyl)-2-(4-acryloxytriethoxyphenyl)propane.

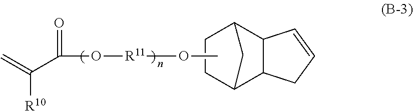

In Formula (B-3), R¹⁰ represents a hydrogen atom or —CH₃; R¹¹s each independently represent a hydrogen atom or a linear or branched alkyl group having 1 to 4 carbon atoms; and n represents an integer from 0 to 10.

Specific examples of the compound represented by Formula (B-3) include dicyclopentenyl(meth)acrylate, dicyclopentenyloxyethyl(meth)acrylate, and dicyclopentenyloxypropyl(meth)acrylate.

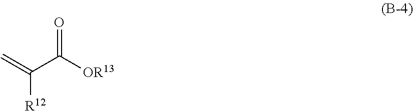

In Formula (B-4), R¹² represents a hydrogen atom or —CH₃; R¹³ represents a hydrogen atom, a linear or branched alkyl group having 1 to 18 carbon atoms; a cyclic alkyl group having 5 to 20 carbon atoms, a phenyl group, a tetrahydrofurfuryl group, or a linear or branched alkyl group having 5 to 20 carbon atoms and having these groups.

Specific examples of the compound represented by Formula (B-4) include methacrylic acid, acrylic acid, methyl(meth)acrylate, cyclohexyl(meth)acrylate, tetrahydrofurfuryl(meth)acrylate, 2-ethylhexyl(meth)acrylate, phenyl(meth)acrylate, and benzyl(meth)acrylate.

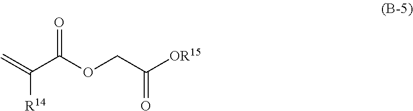

wherein R¹⁴ represents a hydrogen atom, or —CH₃; R¹⁵ represents a linear or branched alkyl group having 1 to 20 carbon atoms, an alkenyl group, an aryl group, an aralkyl group, or a linear or branched alkoxyalkyl group.

Specific examples of the compound represented by Formula (B-5) methoxycarbonyl methyl(meth)acrylate, ethoxycarbonyl methyl(meth)acrylate, heptoxycarbonylmethyl(meth)acrylate, and isopropoxycarbonylmethyl(meth)acrylate.

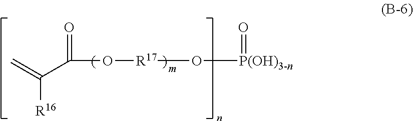

In Formula (B-6), R¹⁶s each independently represent a hydrogen atom or —CH₃; R¹⁷s each independently represent a linear or branched alkylene group having 2 to 4 carbon atoms; m's each independently represent an integer from 1 to 10; and n represents 1 or 2.

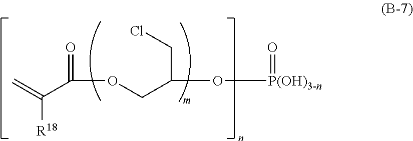

In Formula (B-7), R¹⁸s each independently represent a hydrogen atom or —CH₃; m's each independently represent an integer from 1 to 10; and n represents 1 or 2.

Specific examples of the compound represented by Formula (B-6) or Formula (B-7) include (meth)acryloxyethyl phosphoric acid, 1-chloro-3-(meth)acryloxypropyl-2-phosphoric acid, and (meth)acryloxypropyl phosphoric acid.

Furthermore, as the (meth)acrylate compound have no hydroxyl group, a (meth)acrylate compound having a urethane bond can be used.

Examples of the (meth)acrylate compound having a urethane bond include a reaction product of a (meth)acrylate compound having a hydroxyl group and an organic polyisocyanate compound; and a reaction product of a (meth)acrylate compound having a hydroxyl group, an organic polyisocyanate compound, and a polyol compound and/or diol compound having a valence of 3 or higher.

As a specific example, bis(glycerylurethane)isophorone tetramethacrylate (compound shown below) may be mentioned as a preferable example.

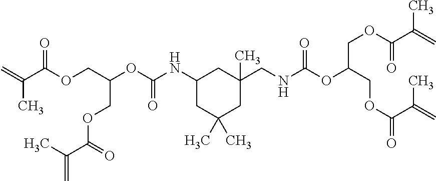 [SMILES: C=C(C)C(=O)OCC(COC(=O)C(=C)C)OC(=O)NCC1(C)CC(NC(=O)OC(COC(=O)C(=C)C)COC(=O)C(=C)C)CC(C)(C)C1]

Among these, the (meth)acrylate compound not having a hydroxyl group preferably includes the compound represented by Formula (B-1) or a (meth)acrylate compound having a urethane bond, more preferably includes the compound represented by Formula (B-1), and even more preferably includes trimethylolpropane tri(meth)acrylate.

One kind of the (meth)acrylate compound not having a hydroxyl group may be used alone, or two or more kinds thereof may be used in combination.

The amount of the methacrylate compound not having a hydroxyl group included in the photocurable adhesive is preferably 20 parts by weight to 90 parts by weight, and more preferably 35 parts by weight to 80 part by weight, based on 100 parts by weight of the photocurable adhesive.

### (Photopolymerization Initiator)

The photocurable adhesive agent preferably include a photopolymerization initiator.

The photopolymerization initiator is not particularly limited, and any known initiator can be used, but the initiator is preferably a photoradical polymerization initiator.

Examples of the photopolymerization initiator include (a) aromatic ketones, (b) onium salt compounds, (d) thio compounds, (e) hexaaryl biimidazole compounds, (f) keto-oxime ester compounds, (g) borate compounds, (h) azinium compounds, (i) metallocene compounds, (j) active ester compounds, and (k) compounds having a carbon-halogen bond. Examples of these radical photopolymerization initiators include the compounds described in JP-A-2008-19408.

Specific examples of the photopolymerization initiator are described extensively in, for example, Bruce M. Monroe, et al., Chemical Reviews, 93, 435 (1993); R. S. Davidson, Journal of Photochemistry and Biology A: Chemistry, 73, 81 (1993); J. P. Faussier, “Photoinitiated Polymerization-Theory and Applications”; Rapra Review, Vol. 9, Report, Rapra Technology (1998); and M. Tsunooka et al., Prog. Polym. Sci., 21, 1 (1996). Furthermore, many compounds that are used in chemically amplified photoresists as photopolymerization initiators, are extensively described in the Japanese Research Association for Organic Electronics Materials, Ed., “Organic Materials for Imaging”, Bunshin Printing Co., Ltd. (1993), pages 187-192. Furthermore, a group of compounds which cause oxidative or reductive bonding and cleavage through an interaction with the electron-excited state of sensitizers, as described in F. D. Saeva, Topics in Current Chemistry, 156, 59 (1990); G. G. Maslak, Topics in Current Chemistry, 168, 1 (1993); H. B. Shuster, et al., J. Am. Chem. Soc., 112, 6329 (1990); I. D. F. Eaton et al., J. Am. Chem. Soc., 102, 3298 (1980), and the like, are also known as photopolymerization initiators.

Furthermore, specific examples of the polymerization initiator include benzyl, benzophenone, Michler's ketone, 2-chlorothioxanthone, 2,4-diethylthioxanthone, benzoin, benzoin ethyl ether, benzoin isobutyl ether, benzoin octyl ether, diethoxyacetophenone, benzyl methyl ketal, 1-hydroxycyclohexyl phenyl ketone, diacetyl, methylanthraquinone, acetophenone, 2-hydroxy-2-methylpropiophenone, anthraquinone, and 3,3′,4,4′-tetra(tertiary-butylperoxycarbonyl)benzophenone.

The photopolymerization initiator may be used individually, or two or more kinds may be used in combination.

The content of the photopolymerization initiator in the photocurable adhesive agent is preferably 0.1 to 20 parts by weight, and more preferably 0.1 to 10 parts by weight, relative to 100 parts by weight of the photocurable adhesive agent.

The process for producing a flexographic printing plate precursor for laser engraving of the present invention preferably includes a step of curing the photocurable composition layer by irradiating the layer with active radiation. In this case, examples of the active radiation include visible light, ultraviolet light, electron beams, and the like, and among these, ultraviolet light is most preferable. In addition, light irradiation is preferably performed on the entire surface of the photocurable composition layer. In cross-linking performed by light, if the support side of the recording layer is taken as a back surface, only the front surface may be irradiated with light. However, when the support is a light-transmissive transparent film, it is preferable that the back surface side be also irradiated with light. The irradiation performed on the front surface side may be carried out in a state where another support is provided or may be carried out after another supporter is peeled off. For the light irradiation, known light sources can be used.

### (Flexographic Printing Plate and Process for Making the Same)

The process for making a flexographic printing plate (relief printing plate) of the present invention includes an engraving step of performing laser engraving on the recording layer of the flexographic printing plate precursor for laser engraving that is obtained by the process for producing a flexographic printing plate precursor for laser engraving of the present invention so as to form a relief layer.

The flexographic printing plate of the present invention is a flexographic printing plate having a relief layer that is obtained by performing laser engraving on the recording layer of the flexographic printing plate precursor for laser engraving obtained by the process for producing a flexographic printing plate precursor for laser engraving of the present invention.

The flexographic printing plate of the present invention can be suitably usable for printing an aqueous ink.

### <Engraving Step>

The process for making a flexographic printing plate of the present invention preferably comprises an engraving step of the above-mentioned recording layer of the flexographic printing plate precursor for laser engraving produced by the process for producing the flexographic printing plate for laser engraving.

The engraving step is a step of laser-engraving the recording layer to thus form a relief layer. Specifically, it is preferable to engrave the recording layer by irradiation with laser light according to a desired image, thus forming a relief layer. Furthermore, a step in which the recording layer is subjected to scanning irradiation by controlling a laser head using a computer in accordance with digital data of a desired image can preferably be cited.

This engraving step preferably employs an infrared laser. When irradiated with an infrared laser, molecules in the recording layer undergo molecular vibration, thus generating heat. When a high power laser such as a carbon dioxide laser or a YAG laser is used as the infrared laser, a large quantity of heat is generated in the laser-irradiated area, and molecules in the recording layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the recording layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is further preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, and ‘Applied Laser Technology’ The Institute of Electronics and Communication Engineers, etc.

Moreover, as plate making equipment comprising a fiber-coupled semiconductor laser that can be used suitably in the process for making a flexographic printing plate employing a flexographic printing plate precursor of the present invention, those described in detail in JP-A-2009-172658 and JP-A-2009-214334 can be cited.

The process for making a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid containing water as a main component.

Drying step: a step of drying the engraved relief layer.

Post-crosslinking step: a step of further crosslinking the relief layer by applying energy to the engraved relief layer.

After the above-mentioned step, since engraving residue is attached to the engraved surface, a rinsing step of washing off engraving residue by rinsing the engraved surface with water or a liquid containing water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin relief printing starting plate, and when slime due to engraving residue cannot be eliminated, a rinsing liquid to which a soap or a surfactant is added may be used.

When the rinsing step of rinsing the engraved surface is carried out, it is preferable to add a drying step of drying an engraved recording layer so as to evaporate rinsing liquid.

Furthermore, as necessary, a post-crosslinking step for further crosslinking the recording layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, yet more preferably no greater than 13.2, particularly preferably no greater than 13, and most preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound. In the present invention, the structures of N═O of an amine oxide compound and P═O of a phosphine oxide compound are considered to be N⁺—O⁻ and P⁺—O⁻ respectively.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

The flexographic printing plate of the present invention having a relief layer may be produced as described above.

From the viewpoint of satisfying suitability for various aspects of flexographic printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 0.3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention is particularly suitable for printing by a flexographic printer using an aqueous ink, but printing is also possible when it is carried out by a letterpress printer using any of aqueous, oil-based, and UV inks, and printing is also possible when it is carried out by a flexographic printer using a UV ink.

According to the present invention, it is possible to provide a process for producing a flexographic printing plate precursor for laser engraving that contains only a small amount of a residual radical polymerizable compound and has a sufficiently cured relief forming layer.

In addition, even when a step of pasting another support onto the thermally cured relief forming layer (recording layer) by using a photocurable composition is further added, it is possible to paste another support with a strong adhesive strength.

### EXAMPLES

The present invention is explained in further detail below by reference to Examples, but the present invention should not be construed as being limited to these Examples.

### Example 1

Thermosetting compositions were prepared and applied in the following manner.

The respective components described in Table 1 were dissolved in propylene glycol monomethyl ether acetate, thereby preparing thermosetting compositions A and B having a solid content concentration of 60% by weight.

Subsequently, a spacer (frame) having a thickness of 3 mm was provided onto a PET substrate, and in a horizontal state, the above components held at 70° C. were cast to the thickness of this frame. A finishing film thickness after drying was 1.5 mm.

The compositions were held at room temperature (25° C.) in the atmosphere set to the oxygen concentration and the pressure condition shown in the section of the “conditions of first curing” of Table 2, and then the temperature of the oven was raised at a rate of 5° C./min to a holding temperature of 100° C. Thereafter, the temperature was held at the holding temperature of 100° C. for 30 minutes.

Subsequently, the compositions were held at room temperature (25° C.) in the atmosphere set to the oxygen concentration and the pressure condition shown in the section of the “conditions of second curing” of Table 2, and then the temperature of the oven was raised at a rate of 5° C/min to the holding temperature of 100° C. shown in the above section of Table 2. Thereafter, the temperature was held at this holding temperature for 30 minutes.

Details of the materials used for preparing the thermosetting compositions A and B of Table 1 are as follows.

DCP: Tricyclodecane dimethanol dimethacrylate (Component A1, manufactured by Shin-Nakamura Chemical Co., Ltd.)

PBZ: PERBUTYL Z (Component B, manufactured by NOF CORPORATION)

Carbon black (Component C, primary particle size of 20 nm)

PVB: Polyvinyl butyral (Component D, Denka BUTYRAL #3000-2, manufactured by DENKI KAGAKU KOGYO KABUSHIKI KAISHA, Mw=90000)

SI: Styrene-Isoprene block copolymer (Component D, Quintac 3421, manufactured by ZEON CORPORATION, Japan)

Tributyl citrate (plasticizer) (Component F, Merck KgaA)

TEOS: Tetraethoxysilane (cross-linking agent) (Component E3, Kojundo Chemical Lab. Co., Ltd)

DBU: 1,8-Diazabicyclo[5.4.0]undec-7-ene (condensation reaction catalyst)

Propylene glycol monomethyl ether acetate (solvent)

### EXAMPLES 2 TO 15 AND COMPARATIVE EXAMPLES 1 AND 2

The thermosetting composition A used in Example 1 was used as is, or optionally changed to the thermosetting composition B. Examples 2 to 15 and Comparative Examples 1 and 2 were performed in the same manner as in Example 1, except that the oven used, oxygen concentration (% by volume), atmospheric pressure, ventilation efficiency, and holding temperature were changed as described in Table 2.

Examples 10 and 11 were performed by changing the oven used, oxygen concentration (% by volume), atmospheric pressure, and ventilation efficiency as described in Table 2 and further changing the time for holding the temperature at 100° C. to 1 hour. The second curing was omitted.

As the oven for thermal curing, an inert gas oven INL-45L1 (internal diameter of oven of 450 (W)×450 (H)×450 (D), manufactured by Koyo Thermo Systems Co., Ltd.) or a vacuum drying oven CLB-DP (internal diameter of oven of 450 (W)×450 (H)×450 (D), manufactured by Noritake Co., Limited) was used.

Oxygen concentration and ventilation efficiency were adjusted in the following manner. Air supply ports of the gas oven were connected to lines of nitrogen gas and dry air, and the flow rate of each gas was set so as to be independently controlled, thereby adjusting oxygen concentration by varying the ratio. A ratio (gas flow rate) between nitrogen and air at which a desired oxygen concentration was yielded under room temperature and normal pressure was set. Thereafter, heating and pressure reduction were carried out in this atmosphere. At this time, oxygen concentration was measured using a zirconia oxygen concentration meter LC-450 (manufactured by Toray Engineering Co., Ltd.). In addition, atmospheric pressure was measured using Pirani vacuum gauge PG-D5A (manufactured by SATO VAC INC.).

Since the internal volume of both the ovens is 91 liters, ventilation efficiency is calculated to be 100% under normal pressure if the flow rate of supplied gas is set to 91 liters/min. The flow rate of supplied gas was adjusted so as to yield the intended ventilation efficiency.

### (Measurement of Thickness of Soft Film Layer)

The obtained thermally cured film was cut with a microtome, and the cross-section was measured with a micro-hardness tester (HMV-1, manufactured by Shimadzu Corporation) at an interval of 100 μm, a maximum load of 30 mN, and a maximum indentation depth of 20 μm. A point distant 50 μm from the surface which was the surface (air) side during thermal curing was taken as a starting point, and measurement points were set so as to be distant from each other by 100 μm in the thickness direction from the starting point, thereby performing hardness measurement. A thickness of a soft film layer of 150 μm or less was regarded as a practical range. The results are shown in Table 2. Here, the “thickness of soft film layer” refers to a thickness from the surface side in which the measured hardness is equal to or less than the hardness measured in the direction of the support side. That is, the “thickness of soft film layer” refers to the thickness of a section having such a hardness gradient that the hardness measured from the surface side increases toward the direction of the support side and then becomes an approximately constant value.

(Adhesive Strength with PET Support)

An ultraviolet (UV)-curable adhesive composed as follows was used.

| | |
|---|---|
| 2-Hydroxypropyl methacrylate | 30 parts by weight |
| Trimethylolpropane trimethacrylate | 62 parts by weight |
| 1-Hydroxycyclohexyl phenyl ketone | 8 parts by weight |

A PET support having a thickness of 0.25 mm was pasted using a nip roller such that an average thickness of the UV-curable adhesive layer became 0.1 mm, and after 20 seconds, the above adhesive was cured from the PET support side by using a UV exposure machine (UV exposure machine ECS-151U manufactured by iGrafx LLC., metal halide lamp, exposure for 14 seconds at 1,500 mJ/cm²), thereby preparing the respective flexographic printing plate precursors. The adhesive strength of the respective sheets of the flexographic printing plate precursors prepared was measured as follows.

After the obtained flexographic printing plate precursor was cut in a width of 3 cm, a portion between the PET support and the adhesive layer or a portion between the adhesive layer and the thermally cured layer was peeled and then further peeled in a direction at 180° to the support by using a TENSILON testing machine at a peeling rate of 50 mm/min, thereby measuring a peel force. The maximum value of the peel force was taken as an adhesive strength (unit: N/cm). An adhesive strength of 3.9N/cm or more was regarded as a practical range.

### (Measurement of Interfacial Bleeding of Adhesive Layer)

Interfacial bleeding of the adhesive layer was evaluated as follows.

If bleeding is small, this means that the amount of residual radical polymerizable compound is small.

The cured film was cut in a length of 2 cm, and the cross-section was observed with an optical microscope at 50× magnification. The interface between the adhesive layer and the thermally cured layer was observed over 2 cm to observe whether there was oil drop-like bleeding of a substance. The results of the observation were evaluated as follows.

E (excellent): Oil drop-like bleeding of a substance was not observed.

P (poor): Oil drop-like bleeding of a substance was observed.

In Table 2, the curing conditions of Examples and Comparative Examples and the obtained evaluation results are summarized.

TABLE 1

| | Radical | | Radical | | | | | | | | | | | |
|---|---|---|---|---|---|---|---|---|---|---|---|---|---|---|
| Thermosetting | polymerizable | | polymerization | | Photothermal | | | | | | Cross-linking | | | |
| composition | compound | | initiator | | conversion agent | | Binder | | Plasticizer | | agent | | Base | |
| A | DCP | 15 | PBZ | 1 | Carbon | 3 | PVB | 40 | Tributyl | 30 | TEOS | 10 | DBU | 1 |
| | | | | | black | | | | citrate | | | | | |
| B | DCP | 15 | PBZ | 1 | Carbon | 3 | SI | 81 | — | | — | | — | |
| | | | | | black | | | | | | | | | |

(Note)
Mixing ratio is indicated in terms of parts by weight.

TABLE 2

| | | | Conditions of first curing | | | | |
|---|---|---|---|---|---|---|---|
| | Thermo- | | | | Oxygen partial | Ventilation | Holding |
| | setting | Used | Oxygen | | pressure | efficiency | temperature |
| | composition | oven | concentration | Pressure (atm) | (atm) | %/min | (° C.) |
| Example 1 | A | INL-45L1 | 0.05 | 1 | 0.05 | 0 | 100 |
| Example 2 | A | INL-45L1 | 0.01 | 1 | 0.01 | 0 | 100 |
| Example 3 | A | CLB-DP | 0.21 | 0.1 | 0.021 | 0 | 100 |
| Example 4 | A | CLB-DP | 0.21 | 0.01 | 0.0021 | 0 | 100 |
| Example 5 | A | INL-45L1 | 0.05 | 1 | 0.05 | 50 | 100 |
| Example 6 | A | INL-45L1 | 0.01 | 1 | 0.01 | 50 | 100 |
| Example 7 | A | INL-45L1 | 0.002 | 1 | 0.002 | 50 | 100 |
| Example 8 | B | INL-45L1 | 0.08 | 1 | 0.08 | 50 | 100 |
| Example 9 | B | INL-45L1 | 0.01 | 1 | 0.01 | 50 | 100 |
| Example 10 | A | INL-45L1 | 0.05 | 1 | 0.05 | 0 | 100 |
| Example 11 | A | INL-45L1 | 0.01 | 1 | 0.01 | 0 | 100 |
| Example 12 | A | INL-45L1 | 0.01 | 1 | 0.01 | 0 | 130 |
| Example 13 | A | INL-45L1 | 0.01 | 1 | 0.01 | 0 | 85 |
| Example 14 | A | INL-45L1 | 0.01 | 1 | 0.01 | 100 | 130 |
| Example 15 | A | INL-45L1 | 0.01 | 1 | 0.01 | 200 | 130 |
| Comparative | A | INL-45L1 | 0.21 | 1 | 0.21 | 0 | 100 |
| Example 1 | | | | | | | |
| Comparative | A | INL-45L1 | 0.21 | 1 | 0.21 | 50 | 100 |
| Example 2 | | | | | | | |

| | | | | | | Evaluation results | | |
|---|---|---|---|---|---|---|---|---|
| | Conditions of second curing | | | | | Thickness | | |
| | | | Oxygen | | | of | | Interfacial |
| | | | partial | Ventilation | Holding | soft film | Adhesive | bleeding |
| | Oxygen | Pressure | pressure | efficiency | temperature | layer | strength | of adhesive |
| | concentration | (atm) | (atm) | %/min | (° C.) | (μm) | (N/cm) | layer |
| Example 1 | 0.21 | 1 | 0.21 | 50 | 100 | 150 | 4.2 | E |
| Example 2 | 0.21 | 1 | 0.21 | 50 | 100 | 150 | 5.5 | E |
| Example 3 | 0.21 | 1 | 0.21 | 50 | 100 | 150 | 5.2 | E |
| Example 4 | 0.21 | 1 | 0.21 | 50 | 100 | 0 | 6.5 | E |
| Example 5 | 0.21 | 1 | 0.21 | 50 | 100 | 0 | 6.3 | E |
| Example 6 | 0.21 | 1 | 0.21 | 50 | 100 | 0 | 6.7 | E |
| Example 7 | 0.21 | 1 | 0.21 | 50 | 100 | 0 | 7 | E |
| Example 8 | 0.21 | 1 | 0.21 | 50 | 100 | 150 | 4.9 | E |
| Example 9 | 0.21 | 1 | 0.21 | 50 | 100 | 0 | 6.6 | E |
| Example 10 | — | — | — | — | — | 150 | 3.9 | E |
| Example 11 | — | — | — | — | — | 150 | 4 | E |
| Example 12 | 0.21 | 1 | 0.21 | 50 | 75 | 120 | 5.6 | E |
| Example 13 | 0.21 | 1 | 0.21 | 50 | 75 | 190 | 5.1 | E |
| Example 14 | 0.21 | 1 | 0.21 | 50 | 75 | 100 | 7.5 | E |
| Example 15 | 0.21 | 1 | 0.21 | 50 | 75 | 60 | 7.7 | E |
| Comparative | 0.21 | 1 | 0.21 | 50 | 100 | 450 | 1.5 | P |
| Example 1 | | | | | | | | |
| Comparative | 0.21 | 1 | 0.21 | 50 | 100 | 350 | 3.5 | P |
| Example 2 | | | | | | | | |

What is claimed is:

1. A process for producing a flexographic printing plate precursor for laser engraving, comprising:
an applying step (1) of applying a composition comprising (Component A) a radical polymerizable compound and (Component B) a thermal radical polymerization initiator onto a support; and
a curing step (2) of thermally curing the composition in an atmosphere in which an oxygen partial pressure is from 0.0001 atm to 0.1 atm.

2. The process for producing a flexographic printing plate precursor for laser engraving according to claim 1,
wherein the curing step (2) includes the first thermal curing sub-step of thermally curing at least a portion of a composition layer obtained by application and the second thermal curing sub-step of further thermally curing the entire of the composition layer.

3. The process for producing a flexographic printing plate precursor for laser engraving according to claim 1,
wherein a ventilation efficiency of the atmosphere in the curing step (2) is 1% by volume/min to 500% by volume/min.

4. The process for producing a flexographic printing plate precursor for laser engraving according to claim 1,
wherein a heating temperature in the curing step (2) is from 60° C. to 200° C.

5. The process for producing a flexographic printing plate precursor for laser engraving according to claim 1,
wherein the composition further comprises (Component C) a photothermal conversion agent.

6. The process for producing a flexographic printing plate precursor for laser engraving according to claim 1,
wherein the composition further comprises (Component D) a binder polymer.

7. The process for producing a flexographic printing plate precursor for laser engraving according to claim 1,
wherein the composition further comprises (Component E) a cross-linking agent.

8. The process for producing a flexographic printing plate precursor for laser engraving according to claim 1,
wherein the composition comprises (Component A1) a polyfunctional ethylenically unsaturated compound as Component A.

9. The process for producing a flexographic printing plate precursor for laser engraving according to claim 7,
wherein Component E is at least one kind selected from a group consisting of (Component E1) a polyfunctional isocyanate compound, (Component E2) a polyfunctional acid anhydride, and (Component E3) a polyalkoxysilane compound.

10. The process for producing a flexographic printing plate precursor for laser engraving according to claim 1, further comprising the steps of
providing a photocurable composition layer onto the surface of the thermally cured composition;
pasting another light-transmissive support onto the photocurable composition layer; and
curing the photocurable composition layer with light.

11. The process for producing a flexographic printing plate precursor for laser engraving according to claim 1,
wherein the composition further comprises (Component G) a solvent, and the applying step (1) includes a sub-step of coating the composition onto the support and a following sub-step of removing 95% by weight or more of the solvent from the composition.

12. The process for producing a flexographic printing plate precursor for laser engraving according to claim 1, comprising:
as the curing step (2), the first thermal curing sub-step of thermally curing at least a portion of the composition layer in an atmosphere in which an oxygen partial pressure is from 0.001 atm to 0.05 atm and at 80° C. to 140° C.; and
the following second thermal curing sub-step of thermally curing the entire of the composition layer in an atmosphere of 1 atm and at 70° C. to 110° C.

13. The process for producing a flexographic printing plate precursor for laser engraving according to claim 12,
wherein a ventilation efficiency in the second thermal curing sub-step is 20% by volume/min to 100% by volume/min.

14. The process for producing a flexographic printing plate precursor for laser engraving according to claim 13,
wherein the photocurable composition layer comprises a (meth)acrylate compound having a hydroxyl group, a (meth)acrylate compound not having a hydroxyl group, and a photopolymerization initiator.

15. The process for producing a flexographic printing plate precursor for laser engraving according to claim 14,
wherein the photocurable composition layer does not comprise volatile organic compounds (VOC) not having an ethylenically unsaturated group.

16. A flexographic printing plate precursor for laser engraving produced by the process according claim 1.

17. A process for making a flexographic printing plate, comprising the steps of:
engraving the flexographic printing plate precursor according to claim 16 with laser; and
washing the laser-engraved printing plate with water or an aqueous solution.

18. A process for making a flexographic printing plate, comprising the steps of:
preparing a flexographic printing plate precursor through the steps comprising the applying step (1) of applying a composition comprising (Component A) a radical polymerizable compound and (Component B) a thermal radical polymerization initiator onto a support; and the curing step (2) of thermally curing the composition in an atmosphere in which an oxygen partial pressure is from 0.0001 atm to 0.1 atm; and
engraving the flexographic printing plate precursor with laser.

19. The process for making a flexographic printing plate according to claim 18,
wherein the preparing step of preparing a flexographic printing plate precursor further comprises, after the applying step (1) and the curing step (2), a step of providing a photocurable composition layer onto the surface of the thermally cured composition, a step of pasting another light-transmissive supporter onto the photocurable composition layer, and a step of curing the photocurable composition layer with light.
